(19) United States
(12) Patent Application Publication
(10) Pub. No.: US 2025/0350988 A1
(43) Pub. Date: Nov. 13, 2025

(54) SYSTEMS AND METHODS FOR CARRIER PHASE POSITIONING

(71) Applicant: ZTE Corporation, Shenzhen (CN)

(72) Inventors: Focai PENG, Shenzhen (CN); Chuangxin JIANG, Shenzhen (CN); Mengzhen LI, Shenzhen (CN); Cong WANG, Shenzhen (CN); Qi YANG, Shenzhen (CN); Junpeng LOU, Shenzhen (CN)

(73) Assignee: ZTE Corporation, Shenzhen (CN)

(21) Appl. No.: 19/213,267

(22) Filed: May 20, 2025

Related U.S. Application Data
(63) Continuation of application No. PCT/CN2023/076823, filed on Feb. 17, 2023.

(51) Int. Cl. H04W 24/10; H04W 76/27

(52) U.S. Cl. CPC H04W 24/10; H04W 76/27

(57) ABSTRACT

Presented are systems and methods for carrier phase positioning. A user equipment (UE) may receive configuration information of a reference signal for positioning from a network. The configuration information may comprise carrier phase-related (CP-related) information configured for the reference signal. The UE may perform a CP measurement on the reference signal based on the CP-related information. The UE may send a report comprising a CP measurement result to the network.

### CROSS-REFERENCE TO RELATED APPLICATION

This application claims the benefit of priority under 35 U.S.C. § 120 as a continuation of PCT Patent Application No. PCT/CN2023/076823, filed on Feb. 17, 2023, the disclosure of which is incorporated herein by reference in its entirety.

### TECHNICAL FIELD

The disclosure relates generally to wireless communications, including but not limited to systems and methods for carrier phase positioning.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A user equipment (UE) may receive configuration information of a reference signal for positioning from a network. The configuration information may comprise carrier phase-related (CP-related) information configured for the reference signal. The UE may perform a CP measurement on the reference signal based on the CP-related information. The UE may send a report comprising a CP measurement result to the network. The report may comprise a time stamp attached to the CP measurement result.

In some embodiments, the configuration information may comprise a PRS Processing Window (PPW) configured for a plurality of carriers within a Positioning Frequency Layer (PFL). The CP measurement may comprise a CP value, when the UE reports timing-related information. The CP measurement may comprise a CP value, when the UE reports angle-related information. The UE can be indicated which of a plurality of carriers or PFLs are to be jointly measured by the network.

In some embodiments, the report may indicate whether the CP measurement is measured over a single PFL or multiple PFLs. The CP measurement can be performed at a center of multiple PFLs. The CP measurement can be performed at a center of multiple carriers, when the UE performs a timing-based measurement on the multiple carriers.

In some embodiments, the CP measurement can be performed within a CP-specific period configured for all of a plurality of PFLs. The CP-specific period can be associated with at least one of: a number of the PFLs, a CP measurement period for one of the PFLs, or an effective reception time of PRS within a period. The CP-specific period can be defined as:

$${T}_{CP , Total} = {\sum }_{i = 1}^{L} {T}_{CP , i} + ( L - 1 ) * {max}_{i = 1}^{L} ( {T}_{effect , i} ) .$$

The parameter L may represent a number of configured PFLs for the CP measurement. The parameter T_{CP,i} may represent the CP measurement period for one single PFL. The max( ) may represent an operation of maximum. The parameter T_{effective,i} may represent the effective reception time of PRS.

In some embodiments, the CP measurement can be performed within a CP-specific period configured for all of a plurality of PFLs. The CP-specific period can be associated with a scaling factor when the CP measurement is performed with a timing-based measurement. The CP-specific period can be defined as:

$${T}_{R STD \_ CP , Total} = {\sum }_{i = 1}^{L} S F * {T}_{R S T D , i} + ( L - 1 ) * {max}_{i = 1}^{L} ( {T}_{effect , i} ) .$$

The parameter SF may represent a scaling factor. The parameter T_{RSTD,i} may represent a measurement period for RSTD for a PFL.

In some embodiments, the CP measurement can be performed within a CP-specific period configured for all of a plurality of PFLs. The CP-specific period can be associated with a scaling factor when the CP measurement is performed with an angle-based measurement. The UE may report its capability on the CP measurement, when the UE is in a Radio Resource Control (RRC) Inactive State. The UE may restart the CP measurement, when one or more symbols of the reference signal are dropped during the CP measurement. The UE may restart the CP measurement, when the CP measurement occurs across two sampling durations.

In some embodiments, the UE may receive a location of the second UE or a second CP measurement associated with a second UE from the second UE. The second UE may broadcast its location and the second CP measurement. The CP measurement can be performed on the reference signal, with a direction and a resolution. The CP measurement can be sent in a second report with a direction and a resolution. The CP measurement can be performed on a same TRP Tx TEG with a timing-based measurement over a same PRS resource.

In some embodiments, the UE may send a request with help from a second UE to a Location Management Function (LMF). The request may comprise at least one of: a coarse location of the UE, an identification of a serving gNB/TRP, an identification of reference signal, an identification of a resource for the reference signal, or an identification of a resource set for the reference signal. The configuration information may comprise a second CP measurement result performed by a second UE. The second CP measurement result may comprise at least one of: a location of the second UE, an identification of a serving gNB/TRP, an identification of a second reference signal, an identification of a resource for the second reference signal, or an identification of a resource set for the second reference signal.

In some embodiments, the UE may receive a request to perform the CP measurement with Q Rx PEG on a same reference signal resource from an LMF network entity. The parameter Q can be an integer. The UE may receive a request to tag the CP measurement with a TEG ID from an LMF network entity. The report may comprise an LOS/NLOS indication for the CP measurement result. The report may comprise an LOS probability for the CP measurement result being higher than an LOS threshold.

In some embodiments, a wireless communication node may receive configuration information of a reference signal for positioning. The configuration information may comprise carrier phase-related (CP-related) information configured for the reference signal. The wireless communication node may perform a CP measurement on the reference signal based on the CP-related information. The wireless communication node may send a report comprising a CP measurement result. The wireless communication node can be configured with multiple PRS resources. The wireless communication node can be configured to broadcast its location with System Information Block (SIB). The report may include a differential CP value indicating which of a plurality of reference PEGs is a first PEG.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example implementation of a carrier phase positioning, in accordance with some embodiments of the present disclosure;

FIG. 4 illustrates an example implementation of a carrier phase positioning, in accordance with some embodiments of the present disclosure;

FIG. 5 illustrates an example implementation of a radio wave with multiple wavelengths, in accordance with some embodiments of the present disclosure;

FIG. 6 illustrates an example implementation of a carrier phase positioning, in accordance with some embodiments of the present disclosure;

FIG. 7 illustrates an example implementation of a carrier phase positioning, in accordance with some embodiments of the present disclosure; and

FIG. 8 illustrates a flow diagram of an example method for carrier phase positioning, in accordance with an embodiment of the present disclosure.

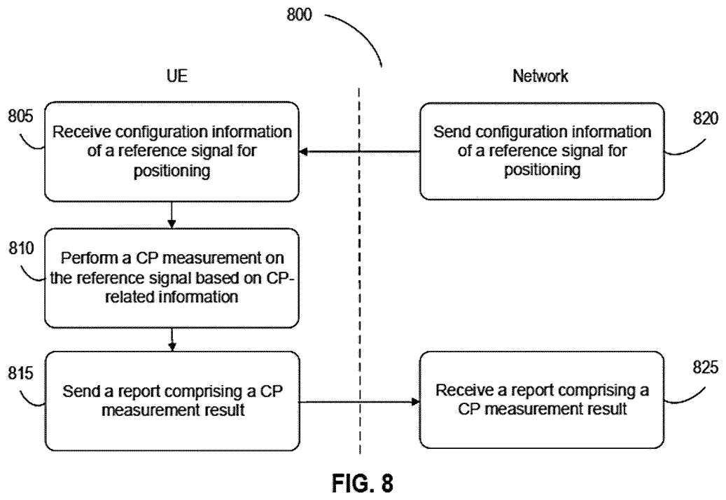

### DETAILED DESCRIPTION

### 1. Mobile Communication Technology and Environment

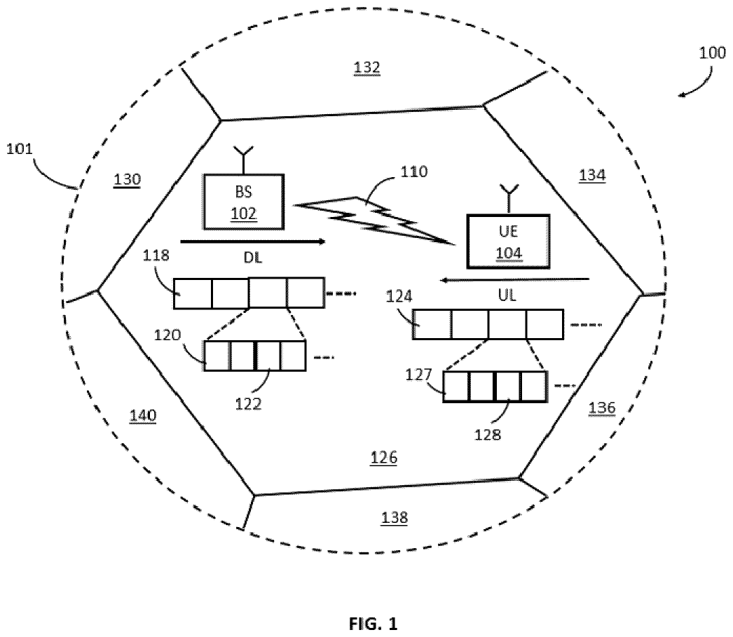

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

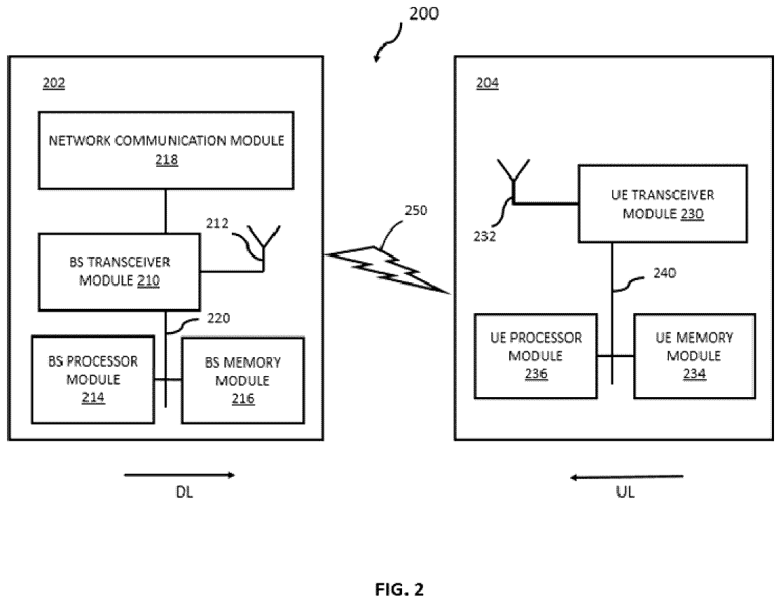

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Carrier Phase Positioning

A demand for positioning is rising up. For example, in a park (especially, an underground park), it may not be easy to find a car (especially, during busy hour). The 5th generation mobile communication system (e.g., 5G, new radio access technology, or 5G-NR) may provide a method for positioning (e.g., positioning reference signal (PRS, from a base station (e.g., gNB)) and/or sounding reference signal (SRS, from a user equipment (UE)) on a radio side. However, a positioning accuracy of the existing 5G-NR-based positioning solutions may not be high enough (e.g., one meter or worse). In some harsh environments (e.g., dense urban area), the positioning accuracy of the existing 5G-NR-based positioning solution can be even worse. In some commerce cases, a positioning accuracy of 0.2 meter can be required. In some cases, a target of some commerce cases (e.g., 0.2 meter) can be hard to be achieved by the existing 5G-NR-based positioning solution. This disclosure is related to positioning accuracy improvement for 5G-NR-based positioning, including but not limited to via a carrier phase positioning (CPP).

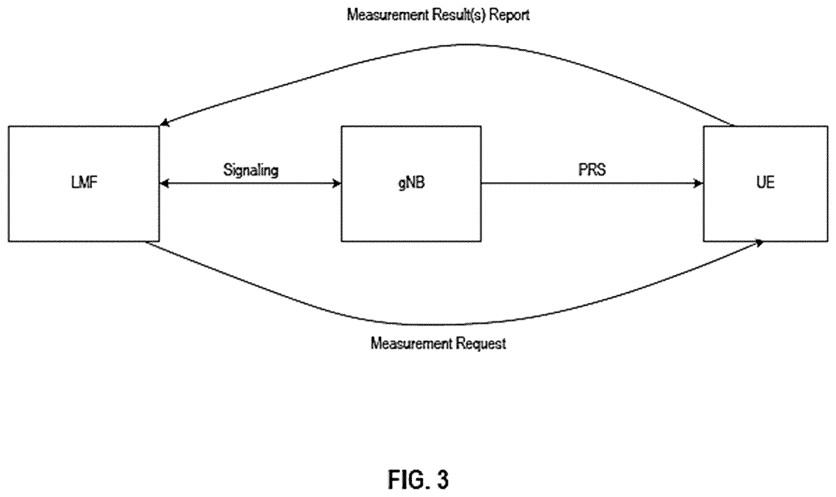

This disclosure relates to a radio communication about how to improve positioning accuracy for a 5G-NR-based positioning. In a downlink (DL) as shown in FIG. 3, a positioning reference signal (PRS) can be transmitted by one or multiple gNBs. In order to achieve a “good” positioning accuracy, multiple gNBs can be involved (e.g., three base stations). A UE may measure at least one PRS. The UE may report measurement result(s) to a network (e.g., a Location Management Function (LMF) in a core network (CN) or a 5G CN (5GC)). A network element may include at least one of: a gNB, a CN, or a UE.

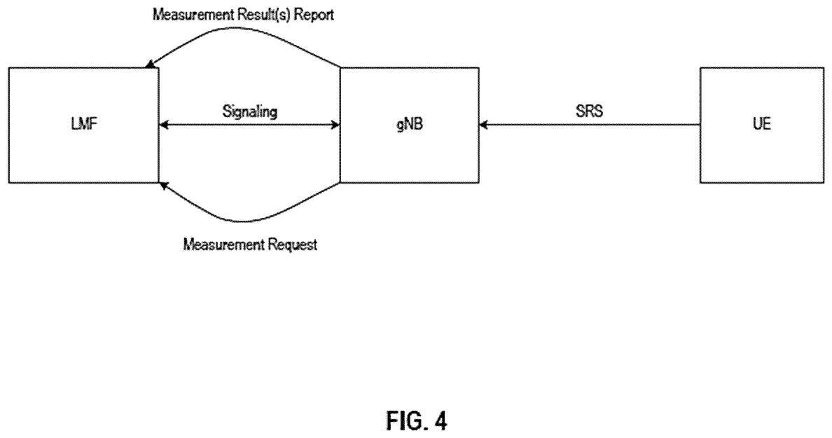

In an uplink (UL) as shown in FIG. 4, a sounding reference signal (SRS) can be transmitted by a UE. One or more gNBs (e.g., multiple gNBs) may measure the SRS. The one or more gNBs may report measurement result(s) to a network (e.g., a LMF).

A transmission of PRS and/or SRS for purpose of positioning can be easily affected by a radio propagation environment (e.g., fading, distortion). Hence, the positioning accuracy can be limited. This disclosure can provide a method for higher positioning accuracy.

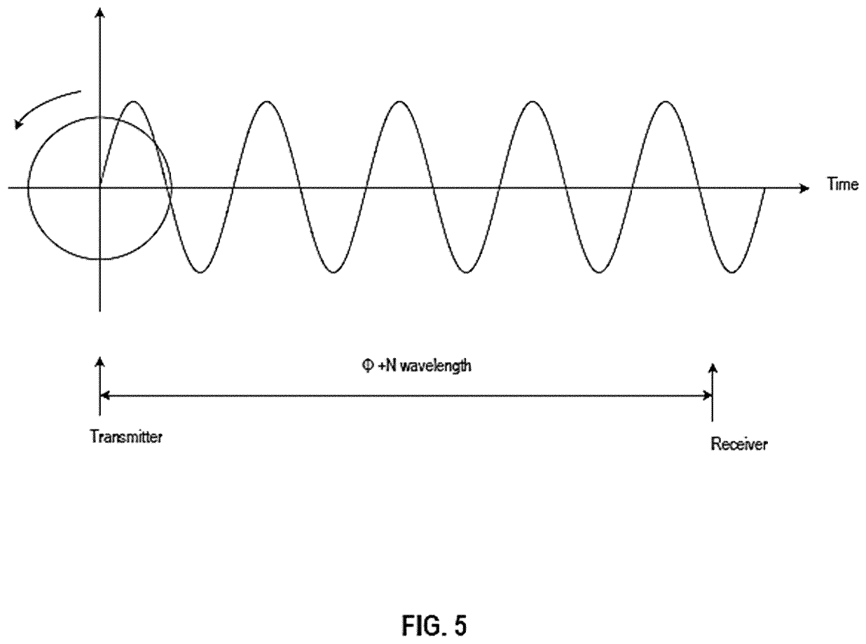

In FIG. 5, a radio wave may travel from a transmitter to a receiver with multiple wavelengths. For a full wavelength, a corresponding carrier phase (or, carrier phase difference between the transmitter and the receiver) can be 2π (equivalently, zero phase). For a fraction part of a wavelength, the corresponding carrier phase can be a value within (0, 2π). If the carrier phase can be measured (and without noise interference, and an assumption of line of sight (LOS) between the transmitter and the receiver), the distance between the transmitter and the receiver (D) can be D=(Φ+N)·λ=(Φ+N)·c/f. Φ can be the fraction part of the measured carrier phase (in unit of 2π, in a range of 0˜1.0). N can be the integer part of the measured carrier phase. λ can be the wavelength of the radio wave transmitted by the transmitter. c can be the velocity of light. f can be the carrier frequency of the radio wave transmitted by the transmitter.

In some embodiments, if a UE can measure the carrier phase (e.g., Φ, N, or Φ+N, where the N can be searched with a specific algorithm), the distance between the transmitter and the receiver can be determined. In certain embodiments, the carrier phase can be only referred to the fraction part (Φ) because the integer N may not be “measured” directly (e.g., it can be guessed, with least error).

### Implementation Example 1

A wireless communication node (e.g., a UE, a base station, or a transmission/reception point (TRP)) may support positioning with multiple carriers (e.g., a positioning frequency layer (PFL)), including a transmission and reception radio signal for positioning. Each carrier/PFL can be measured/reported with a carrier phase (CP) or a differential CP.

In some embodiments, a UE/TRP can measure/report CP with a carrier/PFL list. This carrier/PFL list can be with at least one of: a reference signal ID (e.g., PRS-ID, SRS-ID), a reference signal resource ID (e.g., PRS resource ID, SRS resource ID), reference signal resource set ID (e.g., PRS resource set ID, SRS resource set ID), a physical cell ID (PCI), a global cell ID (CGI), an absolute radio frequency channel number (ARFCN), a subframe offset, a CP value of reference signal on a carrier/PFL, or a PRS Point A. The PCI ID can be a value of 0-1007. The subframe offset can between one TRP and reference TRP. In some embodiments, the CP value can be a differential value that is relative to the reference TRP (or, reference PRS resource). The PRS Point A can be where the PRS starts on frequency. Alternatively, an offset can be added to PRS Point A.

There can be a joint processing CP values from multiple carriers/PFLs. Alternatively, the joint processing may include addition/subtraction of the CP values from multiple carriers/PFLs. The joint processing may include CP measurement on a joint of two or more carriers/PFLs. For example, for two contiguous 100 MHz carriers/PFLs, the bandwidth of this joint carrier/PFL can be 200 MHz. A CP measurement can be performed on this joint carrier/PFL of 200 MHz. Alternatively, the reference signal resource on these carriers/PFLs of the joint carrier/PFL can be same or different.

A time stamp can be attached when UE measures/reports the CP value. The time stamp can be helpful for determining a coarse UE location (e.g., integer range). The carrier/PFL list (or cell list, or serving cell list) may include multiple carriers/PFLs. A PRS processing window (PPW)/measurement gap (MG) can be configured for each carrier/PFL. A PPW can be configured for all the carriers/PFLs within the carrier/PFL list (e.g., this PPW can be shared with multiple carriers/PFLs). A CP value can be measured/reported when a UE measures/reports a timing related value (e.g., time difference of arrival (TDOA), round trip time (RTT), multi-RTT, or reference signal time difference (RSTD)). A CP value can be measured/reported when a UE measures/reports angle related value (e.g., an angle of departure (AoD), an angle of arrival (AoA), a RSRP measurement, or a RSRPP measurement).

In some embodiments, a wireless communication node (e.g., a UE, a gNB, or a TRP) can be (e.g., dynamically) indicated which carrier/PFL is jointly measured (e.g., the CP value can be measured on a large bandwidth after aggregation of two or more carriers). For example, there can be three carriers/PFLs. If the first and the second carrier/PFL are jointly measured while the third one is not, a UE can indicate the first and the second carrier/PFL for jointly processing. In some embodiments, when a wireless communication node (e.g., a UE, a gNB, or a TRP) reports CP value to a LMF, the wireless communication node can indicate which CP value is measured over one single carrier/PFL or multiple carriers/PFLs (e.g., with a carrier/PFL list). In some embodiments, when a wireless communication node (e.g., a UE, a gNB, or a TRP) reports a CP value to a LMF, the wireless communication node can indicate which CP value is measured over one single carrier/PFL or multiple jointly processed carriers/PFLs (e.g., true or false indication with a carrier/PFL list). With this method, a location computation end (e.g., LMF) can calculate a location of a UE more precisely.

There can be a carrier/PFL list. The carriers/PFLs in the carrier/PFL list can be jointly measured/determined. The CP value can be measured on the center of a carrier/PFL. For the joint processing of multiple carriers/PFL, the CP value can be measured on the center of the joint of carriers/PFL. For example, for a joint processing of two carriers/PFLs on 2000 MHz-2100 MHz (with 100 MHz bandwidth) and 2100 MHz-2200 MHz (with 100 MHz bandwidth), the CP value can be measured on the center of the joint of these two carriers (e.g., 2100 MHz). For another example, for a joint processing of two carriers/PFLs on 2000 MHz-2100 MHz (with 100 MHz bandwidth) and 2100 MHz-2160 MHz (with 60 MHz bandwidth), the CP value can be measured on the center of the joint of these two carriers (e.g., 2080 MHz). Alternatively, when the CP value is measured on the joint of these two carriers, the timing based measurements (e.g., TDOA, RTT, or RSTD) can be also measured on the joint of these two carriers. Alternatively, when the timing based measurements (e.g., TDOA, RTT, or RSTD) are measured on the joint of these two carriers, the CP value can be also measured on the joint of these two carriers. Alternatively, when the timing based measurements (e.g., TDOA, RTT, or RSTD) were measured on the joint of these two carriers, the CP value can be also measured on the center of the joint of these two carriers.

If a UE were configured with multiple carriers, one or more carriers can be de-actived (or released). If one carrier were released, the UE can also measure/determine CP on this carrier. Alternatively, if one carrier were released, the UE can also measure CP on a joint of this carrier and other active carrier(s) (e.g., 100 MHz+100 MHz=200 MHz bandwidth, a joint of 200 MHz bandwidth). Alternatively, if one carrier were released, the UE can also measure CP on a joint of this carrier and other released carrier(s).

In some embodiments, the CP measurement can be used for transmitter/receiver phase calibration. For example, if the positioning reference unit (PRU) receiver phase were already calibrated, a LMF can utilize a CP measurement from a PRU and geographic coordinates of a gNB and the PRU for PRS transmission phase calibration.

In some embodiments, a differential CP measurement between two carriers/PFL can be measured/reported. Optionally, a differential CP measurement between two carriers/PFL can be measured/reported with carrier ID (or list of carrier). Optionally, a differential CP measurement between two carriers/PFL can be measured/reported with carrier frequency. Optionally, a differential CP measurement between two carriers/PFLs can be measured/reported with virtual carrier wave length λᵥ=1/(c/f₁−c/f₂). c can be the speed of light. f₁ can be the center frequency of the first carrier. f₂ can be the center frequency of the second carrier. In some embodiments, a differential CP measurement between two carriers/PFLs can be measured/reported with ARFCN. With this method, a phase error caused by delay between two carriers can be removed.

In some embodiments, a differential CP measurement between two sub-carriers can be measured/reported. Optionally, a differential CP measurement between two sub-carriers can be measured/reported with frequency gap between these two sub-carriers (e.g., number of sub-carriers). With this method, a virtual integer can be zero or within a very small range (e.g., 0-10).

In some embodiments, a differential CP measurement between two carriers can be measured/reported with frequency gap between these two carriers/PFLs (e.g., 100 MHz). With this method, a virtual integer can be within a very small range (e.g., 0-30) in a specific scenario (e.g., indoor factory).

With this method, a location computation end (e.g., LMF) can choose appropriate carrier/PFL for location computation. Hence, the performance of positioning can be improved.

### Implementation Example 2

A CP measurement can be performed within a time period. If a PRS collided with other high priority signal, this CP measurement may not be completed within a pre-defined period (e.g., 10 ms, because this UE has to wait next PRS occasion for measurement).

In some embodiments, the CP measurement can be performed over the same measurement period of timing based measurement (e.g., TDOA, RSTD, RTT, or Multi-RTT). There can be a CP specific measurement period. This CP specific measurement period for all the configured carrier/PFL can be associated with at least one of: a number of carrier/PFL (L), a CP measurement period for one single carrier/PFL (T_{CP,i}), an effective reception time of PRS within a period (T_{effect}), a number of beams to be received (e.g., one beam for frequency range 1 (FR 1), eight beams or 64 beams for FR2), a number of resources to be measured within a time slot, a number of samples within a measurement period (e.g., four for normal measurement, two or one for a relaxed measurement), a number of (concurrent) PPW/MG configured for a UE, a number of paths for CP measurement (K), a scaling factor (SF) (e.g., 1.0-2.0) when CP is measured companied with a timing based measurement (e.g., TDOA, RSTD, RTT, or Multi-RTT), or a scaling factor (SF) (e.g., 1.0-3.0) when CP is measured companied with an angle based measurement (e.g., reference signal received power (RSRP), or reference signal received path power (RSRPP)). For example, the SF can be 1.5 times that for TDOA measurement period. For example, the SF can be 2 times that for RSRPP measurement period.

In some embodiments, the CP specific measurement period for all configured PFL (T_{CP,Total}) can be

$${T}_{CP , Total} = {\sum }_{i = 1}^{L} {T}_{C P , i} + L * {max}_{i = 1}^{L} ( {T}_{effect , i} ) .$$

The max( ) can be an operation for maximum. The CP specific measurement period can be applied for a UE under radio resource control (RRC) Connected (RRC_Connected), RRC_Inactive, and/or RRC_Idle state. Optionally, the number of carrier/PFL can be limited to one (e.g., L=1) for a UE under RRC_Inactive or RRC_Idle state.

In some embodiments, the CP specific measurement period for all configured PFL (T_{CP,Total}) can be as the following (e.g., for an operation of differential CP measurement).

$${T}_{CP , Total} = {\sum }_{i = 1}^{L} {T}_{CP , i} + ( L - 1 ) * {max}_{i = 1}^{L} ( {T}_{effect , i} ) .$$

The CP specific measurement period for all configured PFL (T_{CP,Total}) can be as the following.

$${T}_{CP , Total} = {\sum }_{i = 1}^{L} S F * {T}_{RSTD , i} + ( L - 1 ) * {max}_{i = 1}^{L} ( {T}_{effect , i} )$$

$$or$$

$${T}_{R STD \_ CP , Total} = {\sum }_{i = 1}^{L} S F * {T}_{RSTD , i} + ( L - 1 ) * {max}_{i = 1}^{L} ( {T}_{effect , i} ) .$$

The SF can be scaling factor (e.g., 1.3). The T_{RSTD,i} can be measurement period for RSTD for a PFL.

The T_{RSTD_CP,Total} can be for RSTD measurement period with CP measurement (e.g., can be performed at the same time). Optionally, the CP specific measurement period for all configured PFL (T_{CP,Total}) can be SF*T_{RSTD,Total}. The SF can be scaling factor (e.g., 1.2). The T_{RSTD,Total} can be measurement period for RSTD for all configured PFL. Optionally, the CP specific measurement period for all configured PFL (T_{CP,Total}) can be SF*T_{RSRPP,Total}. The T_{RSRPP,Total} can be measurement period for RSRPP for all configured PFL.

In some embodiments, the CP specific measurement period for all configured PFL (T_{CP,Total}) can be

$${T}_{CP , Total} = {\sum }_{i = 1}^{L} S F * {T}_{RSRPP , i} + ( L - 1 ) * {max}_{i = 1}^{L} ( {T}_{effect , i} ) .$$

The SF can be scaling factor (e.g., 1.6). The T_{RSRPP,i} can be measurement period for RSTD for a PFL.

A PRS processing window (PPW) (or measurement gap (MG)) can be configured for a UE for CP measurement on a PRS. If the priority of PRS is lower than other DL signal/channel within the PPW, the UE can drop the PRS without performing a CP measurement.

A UE can report its capability on CP measurement under radio resource control (RRC) inactive state (RRC_Inactive. That is, capability on CP measurement under RRC_Inactive can be reported). Optionally, a UE can report its capability on CP measurement under RRC_Connect state. Optionally, when a UE reports its capability on timing based measurement (e.g., TDOA, RSTD, RTT, or Multi-RTT), the UE may also report its capability on CP measurement. Optionally, when a UE reports its capability on CP measurement, the UE may also report its capability on timing based measurement. Optionally, the capability on CP measurement can be associated with capability on timing based measurement.

In some embodiments, for a reduced capability (RedCap) UE, the UE may report its complexity change when supporting some kind of capability. Optionally, for a RedCap UE, the UE may report its complexity change when supporting CP measurement (e.g., complexity change ratio R=New_Complexity/Old_Complexity, in where, the New_Complexity can be the new complexity after supporting CP measurement, the Old_Complexity can be the complexity without supporting CP measurement. The complexity can be expressed with number of calculation, e.g., 50000 addition). Optionally, for a RedCap UE, the UE may report its complexity change when supporting frequency hopping (e.g., complexity change ratio R=New_Complexity/Old_Complexity. The New_Complexity can be the new complexity after supporting frequency hopping. The Old_Complexity can be the complexity without supporting frequency hopping. A frequency hopping can be a hopping beyond UE's maximum bandwidth, e.g., 20 MHz. A frequency hopping can hopping from one 20 MHz bandwidth to another 20 MHz bandwidth).

The CP measurement reporting delay may include a time used for CP measurement. The CP measurement reporting delay may include a time used for CP measurement on time domain (including distilling a first path). Optionally, the CP measurement reporting delay may include a time used for CP measurement on frequency domain (including CP measurement on multiple sub-carriers (e.g., 3 center sub-carriers), CP measurement on multiple segments of a carriers (e.g., four segments)). Optionally, the CP measurement reporting delay can be an addition to that of timing based measurement (e.g., TDOA) reporting delay.

In some embodiments, if the CP measurement is performed under timing based measurement (e.g., TDOA), there can be a scaling factor for the timing based measurement period (e.g., 1.0-2.0 times of that of timing based measurement period). In some embodiments, if the CP measurement is associated with timing based measurement (e.g., TDOA), there can be a scaling factor for the timing based measurement period (e.g., 1.0-2.0 times of that of timing based measurement period). In some embodiments, if the CP measurement is performed under timing based measurement (e.g., TDOA) under RRC_Inactive, there can be another scaling factor for the timing based measurement period (e.g., 1.0-1.5 times of that of timing based measurement period).

In some embodiments, if the CP measurement is performed under reference signal received power (RSRP) based measurement (e.g., per path RSRP, RSRPP, e.g., angle related measurement, e.g., RSTD measurement), the CP measurement period can be related to the number of paths (e.g., times of number of paths).

In some embodiments, within a measurement period (e.g., within a CP measurement period, e.g., within a PPW), if there are multiple PRS resources for measurement, a UE can select one or more PRS resources for CP measurement, but the total measurement may not exceed its capability of CP measurement. Optionally, there can be a UE capability limitation on PRS resources for CP measurement (e.g., two resource sets per TRP per PFL, one PRS resource per set). Optionally, there can be a UE capability limitation on PRS resources per band for CP measurement (e.g., 1, 2, . . . , 256 resource sets per band, possible with different value for FR 1 and FR2). Optionally, there can be a UE capability limitation on PRS resources per band combination for CP measurement (e.g., 1, 2, . . . , 256 resource sets per band combination). The capability limitation may be reported by a UE (in UE capability report). Optionally, there can be a UE capability limitation on duration of PRS processing symbols for CP measurement (e.g., 0.0625, 0.125, 0.25, . . . , 100 ms). Optionally, there can be a scaling factor for the CP-specific period (e.g., 1.0-2.0). Optionally, there can be a UE capability limitation on duration of PRS processing symbols in every T ms for CP measurement (e.g., T=4, 8, . . . , 2560 ms). Optionally, there can be a scaling factor for the CP-specific period (e.g., 1.0-1.5).

During a measurement period (e.g., within a CP measurement period), if some operation (e.g., time alignment, TA, TA adjustment, handover) may cause inaccuracy (or change) of CP measurement, a UE can restart CP measurement. Optionally, if some operation may cause inaccuracy (or change) of CP measurement, a UE can continue current CP measurement.

During a measurement period (e.g., within a CP measurement period), if one or more PRS symbols are dropped (e.g, because of lower priority of PRS) when measuring CP, a UE can restart CP measurement. During a measurement period, if one or more PRS symbols are dropped when measuring CP, the number of samples within this period of the UE can be increased (e.g., increment by one).

During a measurement period (e.g., within a CP measurement period), if the operation of CP measurement happened across two sampling duration, the UE can restart CP measurement. Optionally, if the operation of CP measurement happened across two sampling duration, the UE can continue the ongoing CP measurement. Optionally, if the operation of CP measurement happened across two sampling duration, the number of samples within this period of the UE can be increased (e.g., increment by two).

If the time span of the PRS resource instance were greater than UE capability, the UE can omit CP measurement on this PRS resource. Optionally, if the time span of the PRS resource instance were greater than UE capability, the UE can continue CP measurement on this PRS resource. Optionally, if the time span of the PRS resource instance were greater than UE capability, the UE can continue CP measurement on this PRS resource but within the time span indicated by the UE. If the PRS had lower priority than other signal/channel (within a PPW) when performing CP measurement, the UE can continue CP measurement on this PRS resource.

With this method, the CP can be measured more precisely. Hence, the performance of positioning can be improved with accurate CP value(s).

### Implementation Example 3

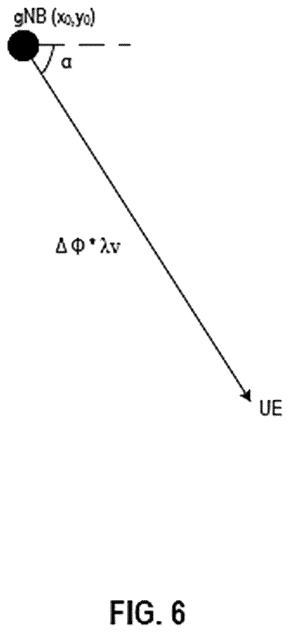

As shown in FIG. 6, a UE can calculate its location within a single site.

A LMF may configure a gNB with a PRS resource (e.g., one PRS resource for one antenna of gNB/TRP). A gNB may broadcast its location coordinates (x0, y0) (e.g., on system information block (SIB)) and may transmit a PRS. By the way, the location coordinates of the gNB (x0, y0) can also be forwarded to a UE by the LMF.

A UE may receive the gNB's location coordinates and the PRS. The UE may calculate AoA/AoD (α) with one or multiple PRS resources. The UE may calculate the distance between itself and gNB d=ΔΦ*λv. λv=1/(1/λ1−1/λ2). ΔΦ=ΔΦ1−Φ2. λv can be virtual wavelength. λ1 can be wavelength for frequency #1. λ2 can be wavelength for frequency #2. Φ1 can be CP measured on frequency #1. Φ2 can be CP measured on frequency #2. The integer parts for frequency #1 and frequency #2 can be the same (for ΔN=0).

The UE may calculate its location coordinates (x, y). x=x0+ΔΦ*λv*cos(α), y=y0+ΔΦ*λv*sin(−α).

Multiple gNBs can be involved to improve positioning accuracy (e.g., by averaging, filtering, and/or optimization from multiple measurement results). With this method, a UE can locate itself with the CP measurement.

### Implementation Example 4

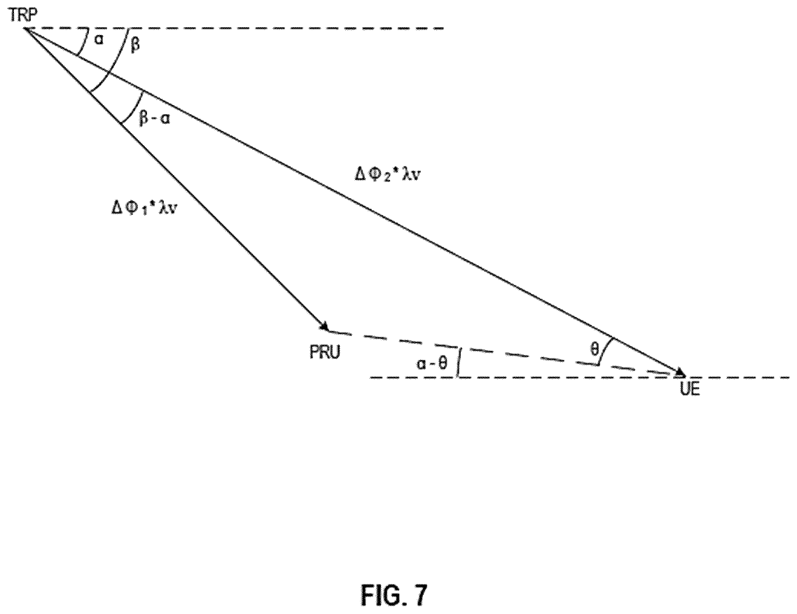

As shown in FIG. 7, a UE can calculate its location within a single site with help from positioning reference unit (PRU), which can be similar to a UE with known location or fixed location.

A LMF may configure a TRP/gNB with a PRS resource (e.g., one PRS resource for one antenna of gNB/TRP). A PRU may broadcast its location coordinates (x₀, y₀) (e.g., broadcast or SIB). In certain embodiments, the PRU may broadcast its location coordinates via a sidelink between UEs). By the way, the location coordinates of the PRU (x₀, y₀) can also be forwarded to a UE by a LMF. A gNB may transmit a PRS.

A UE may receive PRU's location coordinates (x₀, y₀) and gNB's PRS. The PRU may calculate AoA/AoD (β) with one or multiple PRS resources. The PRU may broadcast the AoA/AoD (β) value. In addition, the AoA/AoD (β) value can be forwarded to a UE by the LMF. The UE may calculate AoA/AoD (α) with one or multiple PRS resources, and may receive the AoA/AoD (β) value. After that, the UE may calculate angle ∠UE_TRP_PRU=β−α.

The UE may calculate a distance between itself and gNB d=ΔΦ₁*λᵥ. λᵥ=1/(1/λ₁−1/λ₂). ΔΦ₁ can be a differential CP which can be broadcasted by a PRU. The PRU may calculate the distance between itself and gNB d₂=ΔΦ₂*λᵥ. ΔΦ₂ can be a differential CP. The PRU may broadcast the value d₂=ΔΦ₂*λᵥ. By the way, this value can be forwarded to the UE by the LMF. The UE may receive the value d₂=ΔΦ₂*λᵥ.

The UE may calculate a distance between itself and PRU d_{UE_PRU}=sqrt((ΔΦ₁*λᵥ)\hat{ }2+(ΔΦ₂*λᵥ)\hat{ }2−2*ΔΦ₁*λᵥ*ΔΦ₂*λᵥ*cos(β−α)). The UE may calculate the angle θ and, α−θ. The UE may calculate its location coordinates (x, y). x=x₀+ΔΦ*λᵥ*cos(α−θ), y=y₀−ΔΦ*λᵥ*sin(α−θ).

Multiple gNBs can be involved to improve positioning accuracy (e.g., by averaging, filtering, and/or optimization from multiple measurement results). With this method, a UE can locate itself with a CP measurement with help from a PRU.

### Implementation Example 5

If a radio wave from a transmitter does not travel from the center of beam, there can be an antenna phase center offset (PCO). The PCO may affect CP measurement accuracy. Hence, the positioning accuracy based on CP measurement may be impacted. As the result of that, the PCO of a PRU can be addressed.

A PRU may transmit a SRS. A gNB/TRP may measure a carrier phase (CP) on the SRS. For example, a gNB/TRP may measure the CP on the SRS from 0 to 180 degree with a resolution of 0.1 degree. That is, there can be 180/0.1=1800 CP values on different directions. The gNB/TRP may report these CP values to a LMF. The LMF calculate the direction angle and distance of PRU relative to the gNB/TRP. The LMF can adjust the CP (or PCO) with the direction angle and distance when calculating UE's location. The LMF can also forward the PCO to be adjusted to the PRU.

In some embodiments, a gNB/TRP can indicate its PRS beam information (e.g., the beam associated PRS ID) or spatial direction information (e.g., 0-360 degree). A PRU may measure/report CP values on the PRS beam information to the LMF. Optionally, a PRU may measure/report CP values of PRS on the PRS beam information with a range (e.g., ±10 degree) and a resolution (e.g., 0.05 degree, there can be 2*10/0.05=400 CP values). Optionally, these CP values can be reported with corresponding direction when measuring. Optionally, these CP values can be reported with corresponding direction with a resolution when measuring. With these CP values and corresponding direction, a LMF can adjust PCO and can get a correct CP value.

In some embodiments, a UE can report its PRS quasi-colocation (QCL) processing capability, if requested by a LMF. With this information, a gNB can configure an appropriate beam of PRS for the UE, which may improve CP measurement accuracy which can enhance the positioning accuracy for CP based positioning.

In some embodiments, a LMF can configure a PRS resource set on a TRP transmission timing error group (TEG, or Tx TEG) for a TRP/gNB. A PRS resource set can have several PRS resources (e.g., one for one antenna, a TEG can have several antennas). Under this configuration, a UE can measure the CP on the same time with timing based measurement (e.g., TDOA) over the same PRS resources. Optionally, a UE can measure the CP on the same TRP Tx TEG with timing based measurement (e.g., TDOA) over the same PRS resources. With this method, the carrier phase of fine direction can be measured. Hence, the performance of positioning can be improved.

### Implementation Example 6

A PRU can measure a CP (Φ1) on a PRS resource from a gNB/TRP. The PRU can report the CP to a LMF. However, a normal UE may not know the CP measured by the PRU (Φ1).

For a single differential (and double differential) based CP positioning, a CP measurement from a PRU can be helpful for removing time offset between a UE and a gNB (and, time offset between a gNB and a gNB) which can improve positioning accuracy.

In some embodiments, a PRU can report phase error: abs(True_CP_Value−CP_Measured), where the abs( ) can be for abstraction operation, the True_CP_Value can be the true CP value (e.g., from its location and gNB's location), the CP_Measured can be a CP measurement result. The PRU/UE can compute/report a phase error from different antenna, PEG, TEG to the LMF.

In some embodiments, a UE/PRU can measure/report Doppler frequency shift (or speed of a UE) when measuring CP. It can be used to reduce phase error caused by Doppler shift.

In some embodiments, a UE/PRU can measure/report quality of CP when measuring CP. For example, the UE/PRU can measure variance, standard deviation (STD), path loss, signal strength, RSRP, and/or RSRPP of the first path when measuring CP (or differential CP).

For UE-based positioning (e.g., a UE may calculate its location by itself), the single differential operation (and double differential operation) can be helpful for improving positioning accuracy. Hence, it is beneficial that a normal UE can know the CP measured by the PRU (Φ1).

A UE can request to a LMF for CP measurement from a PRU. The request may include at least one of: a coarse location of itself (e.g., several meters around its true location), a serving gNB/TRP ID, a PRS ID, a PRS resource ID, a PRS resource set ID, a CP measurement by itself, or an antenna reference point (ARP) ID. The ARP ID can be used for determining which ARP is selected.

After receiving a request, the LMF can forward an optimal CP measurement from one or more PRUs. The forwarded information can include at least one of: a location of itself (e.g., geographic coordinates), a serving gNB/TRP ID, a PRS ID, a PRS resource ID, a PRS resource set ID, or a CP measurement from a PRU. The CP measurement can also be CP measurement results and corresponding location.

In some embodiments, a UE can transmit some kind of signal/channel to a gNB to request CP measurement from nearby PRU. After receiving the request, the gNB can request its serving PRU (or UE) to report CP measurement results. After collecting CP measurement results, the gNB can broadcast the collected CP measurement results from the PRU. The UE can receive CP measurement results forwarded by its serving gNB.

In some embodiments, a UE can transmit some kind of sidelink signal/channel to a PRU to request CP measurement from nearby PRU. The PRU may response with CP measurement from itself. Optionally, a PRU may response with CP measured on PRS from a gNB. Optionally, a PRU may response with CP measured on sidelink PRS from a UE. Optionally, a PRU may response with CP measured on sidelink PRS from the UE that requests the CP measurement. With this method, the UE-based positioning with CP measurement can be more precise. Hence, the performance of positioning can be improved.

### Implementation Example 7

A UE can measure a CP value on one PRS resource with multiple reception (Rx) phase error group (PEG). A PEG may have one or more antennas. Optionally, a gNB/TRP can measure CP value on one SRS resource with multiple Rx PEG. Optionally, a UE can measure CP value on one PRS resource from a same transmission (Tx) PEG with multiple Rx PEG. Optionally, a gNB/TRP can measure CP value on one SRS resource from a same Tx PEG with multiple Rx PEG.

A measurement end (e.g., UE, or gNB/TRP) can be requested by a LMF to measure a CP with Q (e.g., Q=1, 2, . . . , 32) Rx PEG on a same reference signal resource. Optionally, a measurement end can select which PEG can be used to measure CP. Optionally, a UE can report CP measurement results on CP assistance data (which can be requested by the LMF).

A measurement end can be requested by the LMF to tag a CP measurement with a TEG (or TEG ID, e.g., 0, 1, 2, . . . , 31, including Tx TEG, Rx TEG, Rx-Tx TEG). Optionally, a measurement end can be requested by LMF to associate a CP measurement with a TEG (or TEG ID). Optionally, a measurement end can be requested by LMF to associate a CP measurement with Rx time difference measurement (or Rx-Tx time difference measurement). Optionally, a measurement end can be requested by LMF to associate a PEG for CP measurement with Rx time difference measurement (or Rx-Tx time difference measurement). Optionally, a measurement end can be requested by LMF to associate a CP measurement with a TEG (or TEG ID) for timing based measurement (e.g., TDOA, RSTD, or RTT). For example, the TEG that measures CP measurement and timing based measurement at the same time can be associated. Optionally, a CP measurement result can be tagged with a TEG ID (that is, which TEG measures this CP measurement result). Optionally, a differential CP value can be reported which the reference PEG is the first PEG (e.g., a PEG with ID=0, or a PEG in a first place of a PEG list).

There can be a LOS/non-LOS (NLOS) indication for a CP measurement when a UE reports CP measurement result. Optionally, if a UE did not detect additional path, there can be no LOS/NLOS indication (e.g., LOS only, by default). Optionally, if a UE did not detect additional path when measuring CP, there can be a “No additional path” indication. Optionally, if a UE did not detect additional path when measuring CP, there can be an “Empty” indication. If a UE did not detect additional path when measuring CP, the additional path indication can be empty.

There can be a LOS threshold (or NLOS threshold). If the LOS probability (e.g., 0.9) is higher than the LOS threshold (e.g., 0.6), a CP measurement result can be reported by a UE. If the LOS probability (e.g., 0.4) is lower than the LOS threshold (e.g., 0.7), a CP measurement result can be not reported by a UE.

In some embodiments, the LOS threshold can be a hard value (e.g., 0 for NLOS, 1 for LOS). If the LOS probability is 1 (i.e., 100%), a CP measurement result can be reported by a UE. Otherwise, a CP measurement result may not be reported by a UE.

In some embodiments, there can be a confidence (e.g., 99%) for LOS probability. A higher value can be for a more reliable of LOS accuracy. When a UE reports CP measurement, the UE can also report the environment (e.g., bad area, not bad area, or mixed area) for measurement. This can be helpful for determining LOS status.

In some embodiments, there can be a LOS/NLOS indicator granularity for CP measurement. It can be TRP-specific, PRS/SRS-resource-specific, path-specific, path and PRS/SRS-resource-specific, path and TRP-specific, or all.

A CP measurement can be with an uncertainty (e.g., 0.1 degree, or, 0.001 Rad, a smaller value may indicate a higher measurement accuracy and higher positioning accuracy).

In some embodiments, a UE can report a Tx PEG related information (e.g., SRS resource ID). A TRP/gNB can report a Tx PEG related information (e.g., PRS resource ID). Optionally, a UE can measure/report differential CP between a TRP and a serving TRP (or, reference TRP) when measuring CP. Optionally, a UE can measure/report fine differential CP (or, extended accuracy CP value) between a TRP and a serving TRP (or, reference TRP) when measuring CP (e.g., with 10-20 bits with sign, e.g., 1/2048 Rad resolution).

A LMF can request a UE with expected CP (or, expected differential CP) when a UE reports CP (or, differential CP). In some embodiments, a LMF can request a UE with expected CP uncertainty (or, expected differential CP uncertainty) when a UE reports CP (or, differential CP). With this method, the CP measurement can be more precise. Hence, the performance of positioning can be improved.

It should be understood that one or more features from the above implementation examples are not exclusive to the specific implementation examples, but can be combined in any manner (e.g., in any priority and/or order, concurrently or otherwise).

FIG. 5 illustrates a flow diagram of a method 500 for carrier phase positioning. The method 500 may be implemented using any one or more of the components and devices detailed herein in conjunction with FIGS. 1-4. In overview, the method 500 may be performed by a wireless communication device (e.g., a UE), in some embodiments. Additional, fewer, or different operations may be performed in the method 500 depending on the embodiment. At least one aspect of the operations is directed to a system, method, apparatus, or a computer-readable medium.

A user equipment (UE) may receive configuration information of a reference signal for positioning from a network. The configuration information may comprise carrier phase-related (CP-related) information configured for the reference signal. The UE may perform a CP measurement on the reference signal based on the CP-related information. The UE may send a report comprising a CP measurement result to the network. The report may comprise a time stamp attached to the CP measurement result.

In some embodiments, the configuration information may comprise a PRS Processing Window (PPW) configured for a plurality of carriers within a Positioning Frequency Layer (PFL). The CP measurement may comprise a CP value, when the UE reports timing-related information. The CP measurement may comprise a CP value, when the UE reports angle-related information. The UE can be indicated which of a plurality of carriers or PFLs are to be jointly measured by the network.

In some embodiments, the report may indicate whether the CP measurement is measured over a single PFL or multiple PFLs. The CP measurement can be performed at a center of multiple PFLs (e.g., for a joint processing of multiple PFLs). The CP measurement can be performed at a center of multiple carriers, when the UE performs a timing-based measurement on the multiple carriers.

In some embodiments, the CP measurement can be performed within a CP-specific period configured for all of a plurality of PFLs. The CP-specific period can be associated with at least one of: a number of the PFLs, a CP measurement period for one of the PFLs, or an effective reception time of PRS within a period. The CP-specific period can be defined as:

$${T}_{CP , Total} = {\sum }_{i = 1}^{L} {T}_{C P , i} + ( L - 1 ) * {max}_{i = 1}^{L} ( {T}_{effect , i} ) .$$

The parameter L may represent a number of configured PFLs for the CP measurement. The parameter T_{CP,i} may represent the CP measurement period for one single PFL. The max( ) may represent an operation of maximum. The parameter T_{effective,i} may represent the effective reception time of PRS.

In some embodiments, the CP measurement can be performed within a CP-specific period configured for all of a plurality of PFLs. The CP-specific period can be associated with a scaling factor when the CP measurement is performed with a timing-based measurement. The CP-specific period can be defined as:

$${T}_{R STD \_ CP , Total} = {\sum }_{i = 1}^{L} S F * {T}_{RSTD , i} + ( L - 1 ) * {max}_{i = 1}^{L} ( {T}_{effect , i} ) .$$

The parameter SF may represent a scaling factor. The parameter T_{RSTD,i} may represent a measurement period for RSTD for a PFL.

In some embodiments, the CP measurement can be performed within a CP-specific period configured for all of a plurality of PFLs. The CP-specific period can be associated with a scaling factor when the CP measurement is performed with an angle-based measurement. The UE may report its capability on the CP measurement, when the UE is in a Radio Resource Control (RRC) Inactive State. The UE may restart the CP measurement, when one or more symbols of the reference signal are dropped during the CP measurement. The UE may restart the CP measurement, when the CP measurement occurs across two sampling durations.

In some embodiments, the UE may receive a location of the second UE or a second CP measurement associated with a second UE from the second UE. The second UE may broadcast its location and the second CP measurement. The CP measurement can be performed on the reference signal, with a direction and a resolution. The CP measurement can be sent in a second report with a direction and a resolution. The CP measurement can be performed on a same TRP Tx TEG with a timing-based measurement over a same PRS resource.

In some embodiments, the UE may send a request with help from a second UE (e.g., a positioning reference unit (PRU)) to a Location Management Function (LMF). The request may comprise at least one of: a coarse location of the UE, an identification of a serving gNB/TRP, an identification of reference signal, an identification of a resource for the reference signal, or an identification of a resource set for the reference signal. The configuration information may comprise a second CP measurement result performed by a second UE. The second CP measurement result may comprise at least one of: a location of the second UE, an identification of a serving gNB/TRP, an identification of a second reference signal, an identification of a resource for the second reference signal, or an identification of a resource set for the second reference signal.

In some embodiments, the UE may receive a request to perform the CP measurement with Q Rx PEG on a same reference signal resource from an LMF network entity. The parameter Q can be an integer. The UE may receive a request to tag the CP measurement with a TEG ID from an LMF network entity. The report may comprise an LOS/NLOS indication for the CP measurement result. The report may comprise an LOS probability for the CP measurement result being higher than an LOS threshold.

In some embodiments, a wireless communication node may receive configuration information of a reference signal for positioning. The configuration information may comprise carrier phase-related (CP-related) information configured for the reference signal. The wireless communication node may perform a CP measurement on the reference signal based on the CP-related information. The wireless communication node may send a report comprising a CP measurement result. The wireless communication node can be configured with multiple PRS resources. The wireless communication node can be configured to broadcast its location with System Information Block (SIB). The report may include a differential CP value indicating which of a plurality of reference PEGs is a first PEG.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A wireless communication method for positioning, comprising:
receiving, by a user equipment (UE) from a network, configuration information of a reference signal for positioning, wherein the configuration information comprises carrier phase-related (CP-related) information configured for the reference signal;
performing, by the UE, based on the CP-related information, a CP measurement on the reference signal; and
sending, by the UE to the network, a report comprising a CP measurement result, wherein the CP measurement result comprises a CP value, when the UE reports timing-related information.

2. The wireless communication method according to claim 1, wherein the report comprises a time stamp associated with the CP measurement result.

3. The wireless communication method according to claim 1, wherein the report comprises an LOS/NLOS indication for the CP measurement result.

4. The wireless communication method according to claim 1, wherein the CP measurement is applicable for radio resource control (RRC) connected (RRC_Connected), RRC_Inactive, or RRC_Idle state.

5. A user equipment (UE), comprising:
at least one processor configured to:
receive, via a transceiver from a network, configuration information of a reference signal for positioning, wherein the configuration information comprises carrier phase-related (CP-related) information configured for the reference signal;
perform, based on the CP-related information, a CP measurement on the reference signal; and
send, via the transceiver to the network, a report comprising a CP measurement result, wherein the CP measurement result comprises a CP value, when the UE reports timing-related information.

6. The UE of claim 5, wherein the report comprises a time stamp associated with the CP measurement result.

7. The UE of claim 5, wherein the report comprises an LOS/NLOS indication for the CP measurement result.

8. The UE of claim 5, wherein the CP measurement is applicable for radio resource control (RRC) connected (RRC_Connected), RRC_Inactive, or RRC_Idle state.

9. A wireless communication method for positioning, comprising:
transmitting, from a network to a user equipment (UE), configuration information of a reference signal for positioning, wherein the configuration information comprises carrier phase-related (CP-related) information configured for the reference signal, and wherein a CP measurement is performed on the reference signal based on the CP-related information; and
receiving, by the network from the UE, a report comprising a CP measurement result, wherein the CP measurement result comprises a CP value, when the UE reports timing-related information.

10. The wireless communication method according to claim 9, wherein the report comprises a time stamp associated with the CP measurement result.

11. The wireless communication method according to claim 9, wherein the report comprises an LOS/NLOS indication for the CP measurement result.

12. The wireless communication method according to claim 9, wherein the CP measurement is applicable for radio resource control (RRC) connected (RRC_Connected), RRC_Inactive, or RRC_Idle state.

13. A network, comprising:
at least one processor configured to:
transmit, via at least one transceiver to a user equipment (UE), configuration information of a reference signal for positioning, wherein the configuration information comprises carrier phase-related (CP-related) information configured for the reference signal, and wherein a CP measurement is performed on the reference signal based on the CP-related information; and
receive, via the at least one transceiver from the UE, a report comprising a CP measurement result, wherein the CP measurement result comprises a CP value, when the UE reports timing-related information.

14. The network of claim 13, wherein the report comprises a time stamp associated with the CP measurement result.

15. The network of claim 13, wherein the report comprises an LOS/NLOS indication for the CP measurement result.

16. The network of claim 13, wherein the CP measurement is applicable for radio resource control (RRC) connected (RRC_Connected), RRC_Inactive, or RRC_Idle state.
